(19) United States
(12) Patent Application Publication
(10) Pub. No.: US 2008/0107317 A1
(43) Pub. Date: May 8, 2008

(54) METHOD AND APPARATUS FOR CALCULATING COARSENESS LEVEL IN TARGET ORGAN FROM ULTRASONIC IMAGE

(75) Inventors: Ji Wook Jeong, Daejeon-city (KR); Soo Yeul Lee, Daejeon-city (KR); Jeong Won Lee, Daejeon-city (KR); Done Sik Yoo, Daejeon-city (KR); Seung Hwan Kim, Daejeon-city (KR); Young Sub Ahn, Daejeon-city (KR); June Sik Cho, Daejeon-city (KR)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Electronics and Telecommunications Research Institute, Daejeon (KR)

(21) Appl. No.: 11/754,617

(22) Filed: May 29, 2007

(30) Foreign Application Priority Data
Nov. 7, 2006 (KR) 10-2006-0109584
Apr. 18, 2007 (KR) 10-2007-0037956

(51) Int. Cl. G06K 9/00

(52) U.S. Cl. 382/131

(57) ABSTRACT

Provided are a method and apparatus for quantifying a coarseness level of an organ of a living body from an ultrasonic image. The method includes: obtaining an ultrasonic image of area of an organ of a living body; determining a target area in the ultrasonic image of area; obtaining a quantified representative coarseness level of the target area from a brightness level distribution of pixels in the target area; and calculating a coarseness level of the organ of a living body, corresponding to the quantified representative coarseness level.

### CROSS-REFERENCE TO RELATED PATENT APPLICATIONS

This application claims the benefit of Korean Patent Application No. 10-2006-0109584, filed on Nov. 7, 2006 and Korean Patent Application No. 10-2007-0037956, filed on Apr. 18, 2007 in the Korean Intellectual Property Office, the disclosures of which are incorporated herein in their entirety by reference.

### BACKGROUND OF THE INVENTION

1. Field of the Invention

The present invention relates to a method and apparatus for quantifying a coarseness level in an image of an area of a human body or other animal bodies, and more particularly, to a method of calculating a coarseness level of a target organ by quantifying a representative coarseness level of the target organ from a coarseness level distribution of pixels of an ultrasonic image of area.

2. Description of the Related Art

Sclerosis of human organs, in particular, liver cirrhosis causes various complications. In addition, the sclerosis itself may cause malfunction of organs. For example, a characteristic of liver cirrhosis is that liver parenchyma of a human body is subjected to fibrosis and thus an abnormal regeneration node that is formed between liver cells blocks normal blood flow, and may cause destruction of liver cells. In particular, if people in a particular country drink a large amount of alcohol, that country has a high virulence rate of alcoholic liver cirrhosis. Therefore, there is a growing need to develop a simple and inexpensive method of calculating a degree of fibrosis of organs.

It is known that liver cirrhosis is closely related to fibrosis of tissue in liver parenchyma. Therefore, many methods of quantifying a degree of fibrosis are under development or are currently used. However, there is still a need to develop a simple and inexpensive method of calculating a degree of fibrosis.

For example, computed tomography (CT) is conventionally used to obtain an image of an area of a human organ. CT can provide high-resolution images. In addition, by using CT, a coarseness level pattern of liver parenchyma in an image can be measured relatively independent from photographing techniques and conditions. Due to such advantages, much research into CT is being carried out. However, CT is expensive and causes danger, such as radiation exposure.

In addition, a biopsy is used to identify a degree of fibrosis of organs. The biopsy is a method in which a tissue of an organ, such as a liver (i.e., a liver biopsy), is removed to analyze the tissue and component of the organ. The liver biopsy may provide very fundamental and reliable results over all kinds of diagnoses and examinations of liver disease. However, the liver biopsy is complex and invasive to the human body. In addition, the liver biopsy is performed only after there is assigns of disease, so that the liver biopsy is not a preventive technique.

Ultrasonography is a conventional diagnostic technique based on an image of an area of an organ, such as an abdominal area. The ultrasonography is relatively inexpensive and simple to use. In particular, ultrasonography is safe in that it does not use radioactive rays, and is not invasive.

However, the quality of an ultrasonic image obtained by the ultrasonography is greatly dependent on photographing conditions and techniques, and the reflective characteristics and resolution of an object through which an ultrasound wave passes are irregular. For these reasons, there is a high probability that a person who diagnoses patient's disease may make an arbitrary interpretation on a visual image taken by ultrasonography, thereby lowering the reliability of his/her diagnosis.

At present, the clinical determination of a degree of fibrosis of liver parenchyma is largely divided into four levels, using ultrasonography: normal, mild, moderate, and severe. However, an error committed by therapists who are experienced in diagnosing patients' diseases using ultrasonography, is up to the range of one level in many times, and the probability of the occurrence of an error is 20% at maximum.

Recently, an elasticity modulus imaging technique that uses elastography has been developed. As a result, research into diagnosis of liver cirrhosis based on a change in an elasticity modulus distribution which may show a high occurring possibility of fibrosis is being carried out. This method is advantageous in that the obtained image directly illustrates a change in a coarseness level of a tissue. However, the resolution may be decreased due to a local elasticity module identification algorithm using a secondary displacement measurement value.

Accordingly, there is a strong need to develop a simple and inexpensive method of providing a quantified fibrosis degree using an ultrasonic image while not being affected by photographing conditions.

In response to such a strong need, there are many efforts to calculate a coarseness level using only an ultrasonic image. In this case, however, image characteristics can be distorted due to an irregularity of a coarseness level distribution and resolution and thus it is difficult to quantify the coarseness level and reliability cannot be obtained.

### SUMMARY OF THE INVENTION

The present invention provides a method of quantifying a coarseness level from a representative coarseness level that is obtained by quantifying a coarseness level distribution property of a target organ from an ultrasonic visual image of the target organ and a comparative organ.

The present invention also provides an apparatus used to perform the method of quantifying a coarseness level.

According to an aspect of the present invention, there is provided a method of quantifying a coarseness level of an organ of a living body from an ultrasonic visual image, the method including: (a) obtaining an ultrasonic image of an organ of a living body; (b) determining a target area in the ultrasonic image; (c) obtaining a quantified representative coarseness level of the target area from a brightness level distribution of pixels in the target area; and (d) calculating a coarseness level of the organ of a living body, corresponding to the quantified representative coarseness level.

The process (c) includes: (c1) obtaining a brightness level distribution pattern of the target area; (c2) extracting a representative coarseness level from coarseness levels of the brightness level distribution; and (c3) quantifying the extracted representative coarseness level.

The process (c2) includes: obtaining a statistic indicating a coarseness level distribution of pixels of the target area; and setting a statistical value indicating a coarseness level calculated from the statistic indicating the coarseness level distribution as a representative coarseness level.

The statistical value is a matrix value indicating a coarseness level.

The matrix value is a concurrence matrix indicating a coarseness level.

The process (c3) includes: (c31) determining a comparative area independent of the target area, in the target area; (c32) obtaining a representative coarseness level of the comparative area from a coarseness level distribution of pixels in the comparative area; and (c33) quantifying the representative coarseness level of the target area by using the representative coarseness levels of the comparative area and the target areas.

In the process (c33), the representative coarseness level of the target area is quantified in a relative numerical value with respect to the representative coarseness level of the comparative area.

In the process (c33), the representative coarseness level of the target area is quantified in a linear combination of relative numerical values with respect to the representative coarseness level of the comparative area.

The process (c) includes: (c1) determining at least one target area including the determined target area in the ultrasonic image and at least one comparative area; (c2) obtaining a distribution pattern of quantified representative coarseness levels from the at least one target area and at least one comparative area; and (c3) extracting a quantified representative coarseness level of the ultrasonic image from the distribution pattern.

The quantified representative coarseness level is an average value of the representative coarseness levels of the distribution pattern.

The quantified representative coarseness level is a median value of the representative coarseness levels of the distribution pattern.

The process (d) includes: (d1) collecting samples of the ultrasonic image; (d2) obtaining quantified representative coarseness levels of respective samples and read values of the related coarseness level; (d3) obtaining a proportional function between the quantified representative coarseness levels and the read values of the coarseness level; and (d4) calculating a coarseness level corresponding to the quantified representative coarseness level of the target area by using the proportional function.

According to another aspect of the present invention, there is provided an apparatus for quantifying a coarseness level of an organ of a living body, the apparatus including: a ultrasound photographing unit photographing an organ of a living body to generate an image of the organ of the living body; an area determination unit determining a target area in the generated image; a memory unit storing the generated image or the target area determined by the area determination unit in a form of data; a control unit computing and quantifying a representative coarseness level by using an image data stored in the memory unit to obtain a coarseness level; and a display unit displaying the resultant computing results and coarseness levels obtained from the control unit or displaying the image of the organ of a living body.

The area determination unit includes: a target area determination unit determining at least one target area; and a comparative area determination unit determining at least one comparative area, and the control unit includes: a coarseness level distribution pattern extracting unit obtaining a distribution pattern of quantified representative coarseness levels of the at least one target area and at least one comparative area; and a representative coarseness level extracting unit extracting a quantified representative coarseness level from the distribution pattern of quantified representative coarseness levels obtained from the coarseness level distribution pattern extracting unit.

The control unit includes: a brightness level distribution pattern extracting unit obtaining a brightness level distribution pattern of the target area; a coarseness level extracting unit extracting a representative coarseness level from coarseness levels of the brightness level distribution pattern obtained from the brightness level distribution pattern extracting unit; and a representative coarseness level quantifying unit quantifying the representative coarseness level extracted from the coarseness level extracting unit.

The control unit includes: an image sample data collecting unit collecting samples of the obtained image; a representative coarseness level extracting unit obtaining quantified representative coarseness levels of the samples of the image collected by the image sample data collecting unit; and a coarseness level reading unit obtaining a read value of a coarseness level related to quantified representative coarseness levels from the samples of the image collected by the image sample data collecting unit.

The coarseness level extracting unit includes a pixel statistics unit obtaining a statistical amount indicating a coarseness level distribution of respective pixels of the target area, wherein a statistical value indicating a coarseness level, which is calculated in and output from the pixel statistics unit, is used as a representative coarseness level.

The pixel statistics unit calculates a matrix value.

The area determination unit includes: a target area determination unit determining at least one target area; and a comparative area determination unit determining at least one comparative area, and the representative coarseness level quantifying unit includes: a comparative area representative coarseness level extracting unit obtaining a comparative area representative coarseness level from a coarseness level distribution of pixels in the comparative area determined by the comparative area determination unit; and a coarseness level comparative quantifying unit quantifying a representative coarseness level by comparing the representative coarseness level obtained by the coarseness level extracting unit with the comparative area representative coarseness level obtained by the comparative area representative coarseness level extracting unit.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view illustrating a method of obtaining an ultrasonic image of a human body;

FIG. 2 is a flowchart illustrating a method of quantifying a coarseness level of a target organ from the ultrasonic image, according to an embodiment of the present invention;

FIGS. 3A, 3B and 3C are flowcharts illustrating a method of obtaining a quantified representative coarseness level according to an embodiment of the present invention;

FIG. 4 is a flowchart illustrating a method of obtaining a quantified representative coarseness level according to another embodiment of the present invention;

FIG. 5 is a flowchart illustrating a method of calculating a coarseness level according to an embodiment of the present invention;

FIG. 6 is a schematic block diagram of an apparatus for quantifying a coarseness level of a target organ from an ultrasonic image, according to an embodiment of the present invention;

FIG. 7 is a block diagram of the apparatus of FIG. 6 in which an area determination unit and a control unit are illustrated in detail;

FIG. 8 is a block diagram of the apparatus of FIG. 6 in which a control unit is illustrated in detail;

FIG. 9 is a block diagram of the apparatus of FIG. 6 in which a coarseness level computing unit is illustrated in detail;

FIG. 10 is an ultrasonic image obtained using a method according to an embodiment of the present invention; and

FIG. 11 is a graph of a correlation between a read value of a coarseness level and a quantified representative coarseness level according to an embodiment of the present invention.

### DETAILED DESCRIPTION OF THE INVENTION

A method and apparatus for quantifying a coarseness level of an organ from an ultrasonic image according to an embodiment of the present invention will now be described in more detail with reference to the accompanying drawings, in which exemplary embodiments of the invention are shown. However, when publicly known techniques or structures related to the present invention may unnecessarily make the present invention unclear, the detailed description will be omitted. The terms used in the specification are defined in consideration of functions used in the present invention, and can be changed according to the intent or conventional use methods of clients, operators, and users. Accordingly, definitions of the terms should be understood on the basis of the entire description of the present specification. In the drawings, like reference designators denote like structural elements.

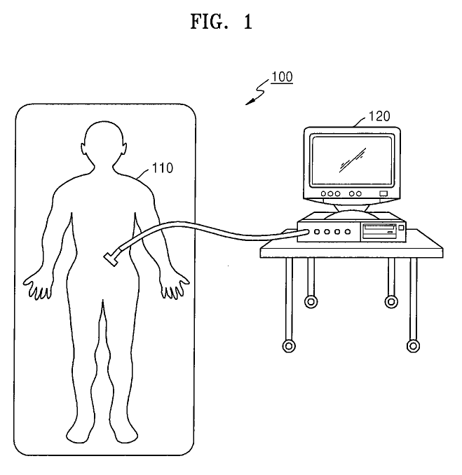

FIG. 1 is a schematic view 100 illustrating a method of obtaining an ultrasonic image of a human body 100.

Referring to FIG. 1, there is a sonograph 120 which is generally found in hospitals. The sonograph 120 includes an ultrasound scanner to examine an inner part of a human body, such as the inside of an abdomen. An ultrasonic image formed as a result of the examination is displayed in a display device included in the sonograph 120.

The present invention provides a method of characterizing a change in reflection refraction properties occurring when a coarseness level in a human body, that is, a coarseness level in a target organ increases, using an ultrasonic image, and calculating a coarseness level from such a change.

An ultrasonic image, for example, an ultrasonic image of an inner abdomen of a human body is a two-dimensional image based on a coarseness level which is derived from reflection refraction properties of each tissue. A tissue is primarily formed of fat and water. Ultrasonic waves have different reflection properties according to the distribution of fat and water. Accordingly, an area with a high coarseness level looks coarse in the ultrasonic image, and thus, coarseness or a coarseness level of respective pixels of the obtained image of the inner abdominal area is proportional to the amount of a fibrous tissue in a tissue area corresponding to each pixel.

However, it is difficult to say that the coarseness or coarseness level of pixels directly shows a coarseness level of a target organ. The reason is that a coarseness level itself may be changed according to photographing conditions and techniques used to obtain an ultrasonic image of an inner abdomen. That is, when an inner abdomen is photographed twice at the same location, the two ultrasonic images of the inner abdomen may have different coarseness levels, or different pixel coarseness levels.

In order to overcome this problem, in the current embodiment of the present invention, a representative coarseness level of a target organ area is measured and then quantified to calculate a coarseness level. That is, by excluding a condition in which an ultrasound image of an area is obtained with respect to a quantified representative coarseness level, a representative coarseness level can be used as an index value of the coarseness level.

Meanwhile, in order to more precisely realize a coarseness level in an ultrasonic photographing process performed on an inner abdomen, it is important to maintain constant photographing conditions. For example, in the ultrasonic photographing process performed on an inner abdomen, the coarseness level distribution in an image may be adjusted to a constant level by controlling photographing angles and a degree of adhesion. In addition, the ultrasonic image may contain all of the to-be-examined organs, such as a liver parenchyma area or a lineal area.

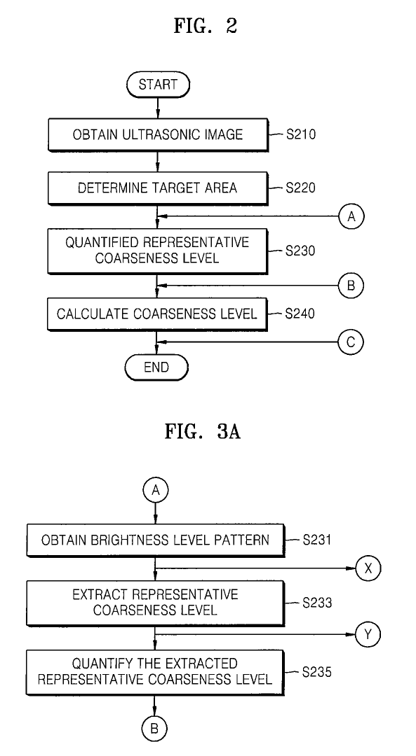

FIG. 2 is a flowchart illustrating a method of quantifying a coarseness level of a target organ from an ultrasonic image, according to an embodiment of the present invention.

First, an ultrasonic image is obtained by using an ultrasonic photographing apparatus (S210). Typically, the ultrasonic image may be an ultrasonic image of an inner abdominal area. Then, a target area is determined from the obtained ultrasonic image (S220).

Next, a quantified representative coarseness level of, for example, liver parenchyma, can be obtained from a brightness level distribution of pixels in the target area (S230).

Finally, a coarseness level corresponding to the quantified representative coarseness level is measured (S240.)

Each process includes further processes, which will be described in detail later.

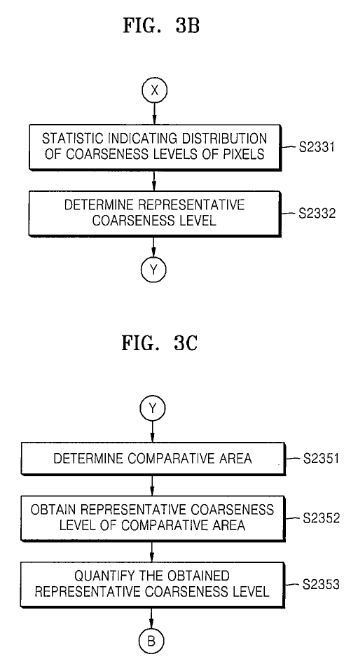

FIG. 3A, FIG. 3B, and FIG. 3C are flowcharts illustrating a method of obtaining a quantified representative coarseness level according to an embodiment of the present invention.

FIG. 3A is a flowchart illustrating process S230 of obtaining a quantified representative coarseness level of FIG. 2, according to an embodiment of the present invention. Process S230 can be divided into three processes. Referring to FIG. 3A, a brightness level distribution pattern of a target area in an ultrasonic image is obtained (S231), a representative coarseness level from coarseness levels of the obtained brightness level distribution pattern is extracted (S233), and then the extracted representative coarseness level is quantified (S235).

The process S233 may be divided into two processes as illustrated in FIG. 3B. That is, a statistic indicating a coarseness level distribution of pixels of the target area is obtained (S2331), and then a statistic value indicating a coarseness level calculated from the statistics indicating the coarseness level distribution is determined as a representative coarseness level (S2332).

In an embodiment of the present invention, the statistic obtained in S2331 may be a matrix value indicating a coarseness level, and the matrix can be a concurrence matrix indicating a coarseness level.

Process S235 of quantifying a representative coarseness level can be divided into three processes as illustrated in FIG. 3C. That is, in the target area, a comparative area distinct from the target area is determined (S2351), a representative coarseness level of the comparative area is obtained from a coarseness level distribution of pixels in the comparative area (S2352), and then a representative coarseness level of the target area is quantified using representative coarseness levels of the comparative area and the target area (S2353).

In an embodiment of the present invention, S2353 can be characterized in that the representative coarseness level of the target area is quantified by a relative numerical value with respect to the representative coarseness level of the comparative area.

In another embodiment of the present invention, S2353 can be characterized in that the representative coarseness level of the target area is quantified by a linear combination of relative numerical values with respect to the representative coarseness level of the comparative area.

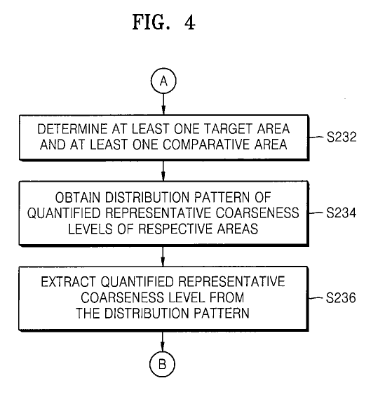

FIG. 4 is a flowchart illustrating in detail process S230 of obtaining a quantified representative coarseness level, as illustrated in FIG. 2, according to another embodiment of the present invention. Specifically, the current embodiment of process S230 is a different embodiment from that described with reference to FIG. 3, and can be divided into three processes.

First, at least one target area including the determined target area in the ultrasonic image and at least one comparative area are determined (S232). Then, a distribution pattern of quantified representative coarseness levels of the at least one target area and at least one comparative area are obtained (S234). Next, a quantified representative coarseness level of the ultrasonic image of the area is obtained from the obtained distribution pattern (S236).

In S236, the quantified representative coarseness level can be computed in various ways. For example, the quantified representative coarseness level can be obtained by calculating an average value of representative coarseness levels of the obtained distribution pattern. Alternatively, the quantified representative coarseness level can be obtained by calculating a median value of the representative coarseness levels of the obtained distribution pattern.

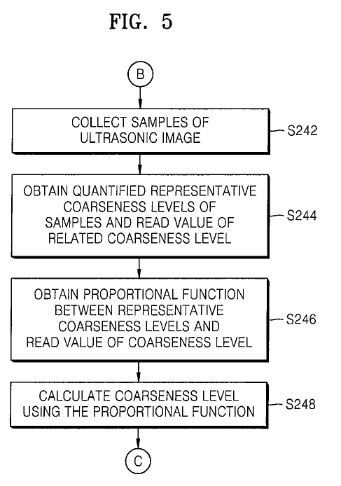

Referring back to FIG. 2, after the quantified representative coarseness level is obtained in process S230, a coarseness level is calculated in S240. FIG. 5 is a flowchart illustrating in detail process S240 of calculating the coarseness level according to an embodiment of the present invention.

The process of calculating a coarseness level will now be described in detail. First, samples of the ultrasonic image of area are collected (S242). Then, quantified representative coarseness levels and read values of related coarseness levels of each collected sample are obtained (S244). Next, it is obtained a proportional function between the quantified representative coarseness levels and the read values of the related coarseness levels (S246). Finally, a coarseness level corresponding to the quantified representative coarseness level of the target area is calculated using the obtained proportional function (S248).

At this time, the ultrasonic image can be an ultrasonic image of an inner abdomen of a human body, and the target image can be an image including a liver.

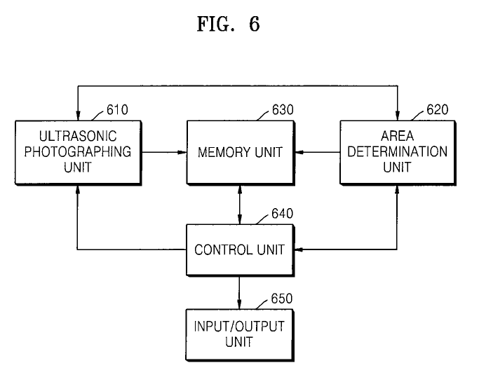

FIG. 6 is a block diagram schematically illustrating an apparatus of quantifying a coarseness level of a target organ from an ultrasonic image, according to an embodiment of the present invention.

An ultrasonic photographing unit 610 may consist of conventional ultrasonic photographing devices. The image data obtained by the ultrasonic photographing unit 610 is stored in a memory unit 630. A control unit 640 calculates, determines, and quantifies a representative coarseness level from the image data stored in the memory unit 630, and calculates a coarseness level from the quantified representative coarseness level.

The obtained ultrasonic image of the inner abdominal consists of pixels having brightness levels in the range from 0 to 255. The number of pixels may varies according to embodiments. For example, the number of pixels may be set to about 500×700. Such data processing may be performed in the control unit 640, and the ultrasonic image may be output through a display device, such as a monitor, of an input/output unit 650.

The control unit 640 generally controls the apparatus for quantifying a coarseness level of an organ of a living body according to the present invention. Typically, the control unit 640 performs control between peripheral units, such as the ultrasonic photographing unit 610, the memory unit 630, the area determination unit 620, or the input/output unit 650. In addition, the control unit 640 performs calculating processes of the peripheral units, such as statistical calculation, matrix calculation, average calculation, or median calculation.

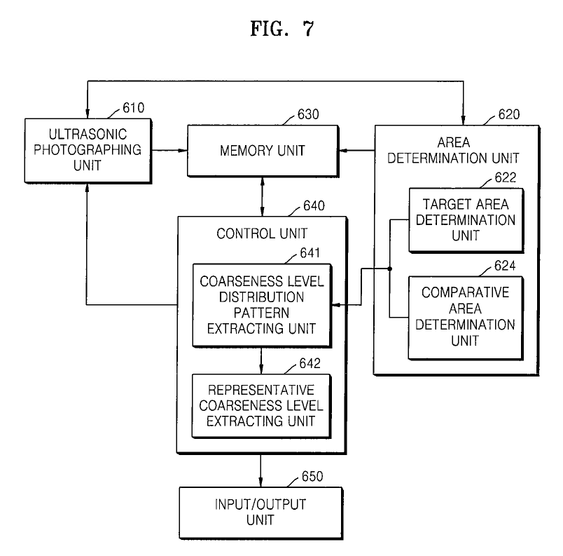

FIG. 7 is a block diagram illustrating in detail the area determination unit 620 and the control unit 640 according to an embodiment of the present invention.

In the apparatus for obtaining an ultrasonic image, the area determination unit 620 determines a target area and a comparative area. In the current embodiment, the area determination unit 620 is divided into a target area determination unit 622 and a comparative area determination unit 624. Representative coarseness levels obtained from respective area determination units are sent to the control unit 640 so that the representative coarseness levels can be compared with each other.

In the control unit 640, a coarseness level distribution pattern extracting unit 641 extracts a distribution pattern using representative coarseness levels obtained from the target area determination unit 622 and the comparative area determination unit 624, and a representative coarseness level extracting unit 642 extracts a quantified representative coarseness level of the ultrasonic image from the obtained distribution pattern.

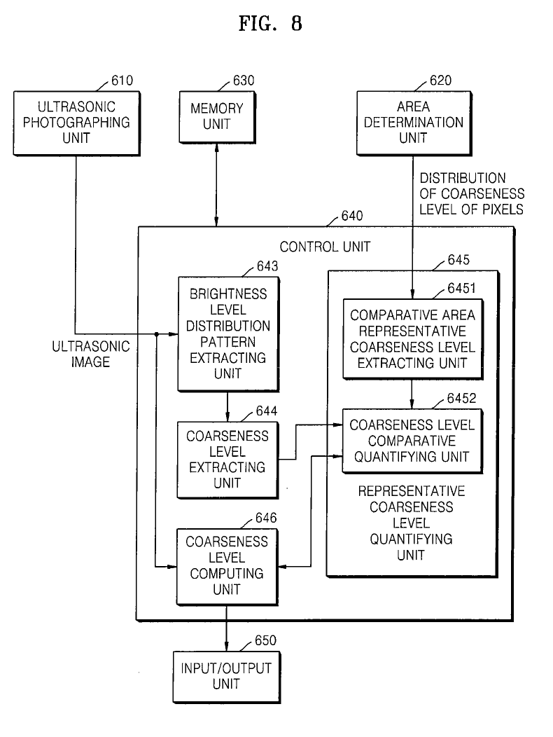

FIG. 8 is a block diagram illustrating in detail the control unit 640 according to an embodiment of the present invention.

Referring to FIG. 8, the control unit 640 includes a brightness level distribution pattern extracting unit 643, a coarseness level extracting unit 644, a representative coarseness level quantifying unit 645, and a coarseness level computing unit 646.

The brightness level distribution pattern extracting unit 643 obtains a brightness level distribution pattern from the target area of the ultrasonic image. In an embodiment, an ultrasonic image of an inner abdomen consists of pixels having a brightness level in the range from 0 to 255. The number of pixels may be set to about 500×700. The coarseness level extracting unit 644 extracts a representative coarseness level from coarseness levels of the obtained brightness level distribution pattern. The extracted representative coarseness level is quantified in the representative coarseness level quantifying unit 645.

The representative coarseness level quantifying unit 645 may include a comparative area representative coarseness level extracting unit 6451 and a coarseness level comparing/quantifying unit 6452.

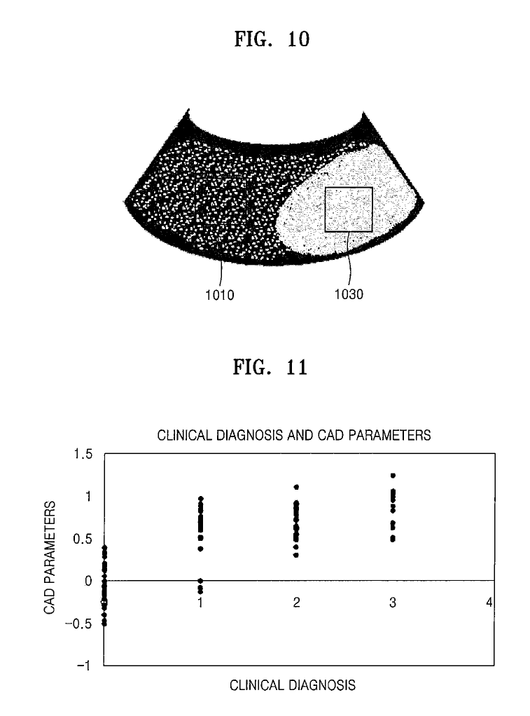

According to an embodiment of the present invention, first, an area of interest in the ultrasonic image is determined so as to extract a representative coarseness level of a target area, such as liver parenchyma, from the ultrasonic visual image of an inner abdomen, which will now be described in detail with reference to FIGS. 8 and 10. The liver parenchyma in the target area in the ultrasonic visual image of an inner abdominal area is determined as a target area 1010, and a comparative area 1030 used to quantify the extracted representative coarseness level of the target area 1010 is determined.

The comparative area 1030 which is used to quantify the target area 1010 that is liver parenchyma can be any organ of a living body that has a texture property independent of development of the lesions of interest. In an embodiment of the present invention, the spleen area 1030 may act as the comparative area.

First, when the determined area is not a liver parenchyma area but the comparative area 1030, a representative coarseness level of the comparative area 1030 is extracted so as to be used as the criteria for quantifying a coarseness level of the target area 1010 of liver parenchyma. The representative coarseness level of the comparative area is determined from a coarseness level distribution of pixels of the comparative area 1030.

For example, a spleen area is determined as a comparative area, a texture parameter value that reflects a coarseness level of the corresponding area is extracted and set as a representative coarseness level of the comparative area 1030 that is a spleen area.

Since the spleen area has constant texture echo characteristics independent from development of liver cirrhosis, it is appropriate to extract the part having a uniform coarseness level distribution for quantifying the representative coarseness level of the target area.

The area determination and computing for extraction of the coarseness level may be performed by the control unit 640, for example, a microprocessor.

Referring to FIG. 8, when the coarseness level distribution of pixels is obtained, the coarseness level distribution is sent to the comparative area representative coarseness level extracting unit 6451 to determine a representative coarseness level of the comparative area. The comparative area representative coarseness level and the representative coarseness level sent by the coarseness level extracting unit 644 are compared and quantified in the coarseness level comparing/quantifying unit 6452.

The representative coarseness level of the comparative area 1030, that is, the spleen area, may be set to 75.6 according to the extracting method described above.

As described above, after a representative coarseness level of the comparative area 1030, which is to be compared with a representative coarseness level of the target area 1010, is obtained, the representative coarseness level of the target area 1010 is calculated.

The liver parenchyma acting as the target area 1010 as shown in FIG. 10 has a relatively uniform texture property, so that the representative coarseness level can be extracted by analyzing the coarseness levels of pixels of the target area 1010.

After the coarseness level distribution of pixels in the target area 1010 is obtained, the representative coarseness level is calculated from the coarseness level distribution. The representative coarseness level of the liver parenchyma target area 1010 may be, for example, 53.6.

In the subsequent quantifying process, the representative coarseness level of the target area 1010 can be quantified in a relative numerical value with respect to other areas in an ultrasonic image of an inner abdomen including the target area 1010.

For example, the representative coarseness level of the target area 1010 is quantified or standardized in a relative numerical value with respect to the representative coarseness level of the comparative area 1030 that is the spleen area having constant texture properties as described above.

That is, the representative coarseness level of the target area 1010 can be quantified using a function given by:

C′=f(C;A)=(C−A)

where C′ denotes a quantified representative coarseness level of the target area 1010, C denotes the representative coarseness level of the target area 1010, and A denotes the representative coarseness level of the comparative area 1030.

f(C;A, B) can be, in addition to the function as described above, any function that monotonously increases.

The quantified representative coarseness level of the target area 1010 obtained using the given function is (53.6−75.6)=−22.0. As such, the representative coarseness level of the target area 1010 is quantified in a relative numerical value with respect to the representative coarseness level of the comparative area 1030. As a result, the representative coarseness level of the target area 1010 can be compared with representative coarseness levels from other ultrasonic image of areas.

After the quantified representative coarseness level of the target area is obtained, a texture parameter is obtained using representative coarseness levels of the comparative area. Specifically, a target part having relatively uniform texture properties in the spleen area is selected and texture parameters are calculated to obtain a quantified representative coarseness level of the target area.

In the coarseness level computing unit 646, a real coarseness level is calculated from the quantified representative coarseness level of the target area 1010.

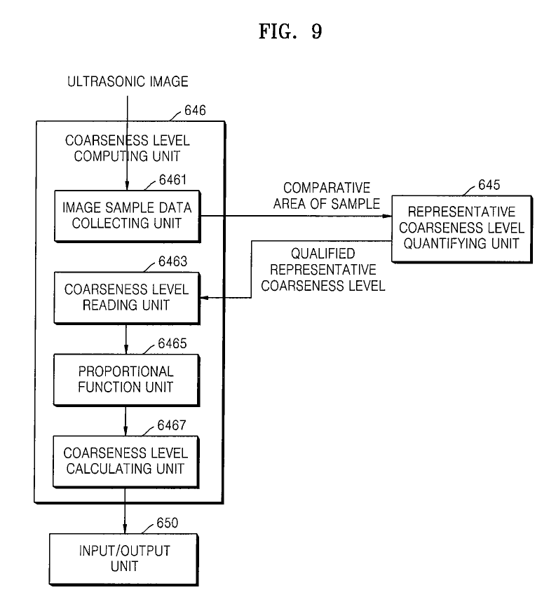

FIG. 9 is a block diagram illustrating in detail the coarseness level computing unit 646.

The coarseness level computing unit 646 includes an image sample data collecting unit 6461, a coarseness level reading unit 6463, a proportional function unit 6465, and a coarseness level calculating unit 6467.

The image sample data collecting unit 6461 collects data of ultrasonic image of area samples from the ultrasonic image. Then, a fibrosis index and quantified representative coarseness level of a target area of each sample, such as liver parenchyma, are obtained. At this time, respective quantified representative coarseness levels can be obtained as described above.

Subsequently, a correlation between quantified representative coarseness levels and fiber indexes of samples is obtained. For example, the correlation can be represented as a quantified representative coarseness level with respective to a fibrosis index, as illustrated in FIG. 11. That is, a quantified representative coarseness level value is obtained to be regarded as a degree of fibrosis (coarseness level).

Then, in the proportional function unit 6465, a proportional function between the fibrosis index and the quantified representative coarseness level can be obtained using, for example, a least square method.

In the coarseness level calculating unit 6467, the quantified representative coarseness level of the target area is applied to such a correlation function to thus obtain a corresponding fibrosis index. Accordingly, the quantified representative coarseness levels obtained according to an embodiment of the present invention can be presumed or considered as a fibrosis index.

FIG. 11 is a graph illustrating correlation between a read value of a coarseness level obtained according to the present invention and a quantified representative coarseness level. By using this graph, the correlation between quantified representative coarseness levels and fibrosis indexes as described above can be obtained.

At this time, fibrosis indexes used may be determination results with respect to coarseness levels of the liver parenchyma made by clinical doctors.

As described above, according to the present invention, a coarseness level distribution of pixels of an ultrasonic image is re-adjusted in a linear form, so that the ultrasonic image can be obtained independently of photographing conditions and techniques, and a representative coarseness level of a target area of an organ of interest can be obtained. In addition, ultrasonic images can be compared to each other by quantifying the representative coarseness level. As a result, a coarseness level of the interest organ can be quantified and a degree of fibrosis can be easily and economically measured.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of quantifying a coarseness level of an organ of a living body from an ultrasonic visual image, the method comprising:
(a) obtaining an ultrasonic image of an organ of a living body;
(b) determining a target area in the ultrasonic image;
(c) obtaining a quantified representative coarseness level of the target area from a brightness level distribution of pixels in the target area; and
(d) calculating a coarseness level of the organ of a living body, corresponding to the quantified representative coarseness level.

2. The method of claim 1, wherein the process (c) comprises:
(c1) obtaining a brightness level distribution pattern of the target area;
(c2) extracting a representative coarseness level from coarseness levels of the brightness level distribution; and
(c3) quantifying the extracted representative coarseness level.

3. The method of claim 2, wherein (c2) comprises:
obtaining a statistic indicating a coarseness level distribution of pixels of the target area; and
setting a statistical value indicating a coarseness level calculated from the statistic indicating the coarseness level distribution as a representative coarseness level.

4. The method of claim 3, wherein the statistical value is a matrix indicating a coarseness level.

5. The method of claim 4, wherein the matrix is a concurrence matrix indicating a coarseness level.

6. The method of claim 2, wherein (c3) comprises:
(c31) determining a comparative area independent of the target area, in the target area;
(c32) obtaining a representative coarseness level of the comparative area from a coarseness level distribution of pixels in the comparative area; and
(c33) quantifying the representative coarseness level of the target area by using the representative coarseness levels of the comparative area and the target area.

7. The method of claim 6, wherein in (c33), the representative coarseness level of the target area is quantified in a relative numerical value with respect to the representative coarseness level of the comparative area.

8. The method of claim 6, wherein in (c33), the representative coarseness level of the target area is quantified in a linear combination of relative numerical values with respect to the representative coarseness level of the comparative area.

9. The method of claim 1, wherein (c) comprises:
(c1) determining at least one target area comprising the determined target area in the ultrasonic image, and at least one comparative area;
(c2) obtaining a distribution pattern of quantified representative coarseness levels from the at least one target area and at least one comparative area; and
(c3) extracting a quantified representative coarseness level of the ultrasonic image from the distribution pattern.

10. The method of claim 9, wherein the quantified representative coarseness level is an average value of the representative coarseness levels of the distribution pattern.

11. The method of claim 9, wherein the quantified representative coarseness level is a median value of the representative coarseness levels of the distribution pattern.

12. The method of claim 1, wherein (d) comprises:
(d1) collecting samples of the ultrasonic image;
(d2) obtaining quantified representative coarseness levels of respective samples and read values of the related coarseness level;
(d3) obtaining a proportional function between the quantified representative coarseness levels and the read values of the coarseness level; and
(d4) calculating a coarseness level corresponding to the quantified representative coarseness level of the target area by using the proportional function.

13. An apparatus for quantifying a coarseness level of an organ of a living body, the apparatus comprising:
an ultrasonic photographing unit photographing an organ of a living body to generate an image of the organ of the living body;
an area determination unit determining a target area in the generated image;
a memory unit storing the generated image of the target area determined by the area determination unit in a form of data;
a control unit computing and quantifying a representative coarseness level by using an image data stored in the memory unit to obtain a coarseness level; and
a display unit displaying the resultant computing results and coarseness levels obtained from the control unit or displaying the image of the organ of a living body.

14. The apparatus of claim 13, wherein the area determination unit comprises:
a target area determination unit determining at least one target area; and
a comparative area determination unit determining at least one comparative area, and
the control unit comprises:
a coarseness level distribution pattern extracting unit obtaining a distribution pattern of quantified representative coarseness levels of the at least one target area and at least one comparative area; and
a representative coarseness level extracting unit extracting a quantified representative coarseness level from the distribution pattern of quantified representative coarseness levels obtained from the coarseness level distribution pattern extracting unit.

15. The apparatus of claim 13, wherein the control unit comprises:
a brightness level distribution pattern extracting unit obtaining a brightness level distribution pattern of the target area;
a coarseness level extracting unit extracting a representative coarseness level from coarseness levels of the brightness level distribution pattern obtained from the brightness level distribution pattern extracting unit; and
a representative coarseness level quantifying unit quantifying the representative coarseness level extracted from the coarseness level extracting unit.

16. The apparatus of claim 14 or claim 15, wherein the control unit comprises:
an image sample data collecting unit collecting samples of the obtained image;
a representative coarseness level extracting unit obtaining quantified representative coarseness levels of the samples of the image collected by the image sample data collecting unit; and
a coarseness level reading unit obtaining a read value of a coarseness level related to quantified representative coarseness levels from the samples of the image collected by the image sample data collecting unit.

17. The apparatus of claim 15, wherein the coarseness level extracting unit comprises a pixel statistics unit obtaining a statistic indicating a coarseness level distribution of respective pixels of the target area, wherein a statistical value indicating a coarseness level, which is calculated in and output from the pixel statistics unit, is used as a representative coarseness level.

18. The apparatus of claim 17, wherein the pixel statistics unit calculates a matrix value.

19. The apparatus of claim 15, wherein the area determination unit comprises:
a target area determination unit determining at least one target area; and
a comparative area determination unit determining at least one comparative area, and
wherein the representative coarseness level quantifying unit comprises:
a comparative area representative coarseness level extracting unit obtaining a comparative area representative coarseness level from a coarseness level distribution of pixels in the comparative area determined by the comparative area determination unit; and
a coarseness level comparative/quantifying unit quantifying a representative coarseness level by comparing the representative coarseness level obtained by the coarseness level extracting unit with the comparative area representative coarseness level obtained by the comparative area representative coarseness level extracting unit.
